(19) United States
(12) Patent Application Publication
(10) Pub. No.: US 2026/0180470 A1
(43) Pub. Date: Jun. 25, 2026

(54) ELECTROSTATIC GUN DRIVER AND PROCESS OF IMPLEMENTING AN ELECTROSTATIC GUN DRIVER

(71) Applicant: NORDSON CORPORATION, WESTLAKE, OH (US)

(72) Inventor: Joseph ELEK, Westlake, OH (US)

(73) Assignee: NORDSON CORPORATION, WESTLAKE, OH (US)

(21) Appl. No.: 19/124,592

(22) PCT Filed: Oct. 12, 2023
(86) PCT No.: PCT/US2023/076661

§ 371 Date: Apr. 25, 2025

Related U.S. Application Data
(60) Provisional application No. 63/420,968, filed on Oct. 31, 2022.

(51) Int. Cl. H02M 7/5387; H02M 1/44; H02M 3/158

(52) U.S. Cl. CPC H02M 7/5387; H02M 1/44; H02M 3/158; H02M 3/1582; H02M 3/1584

(57) ABSTRACT

And electrostatic gun driver includes an inverter configured to receive power from a power supply. The electrostatic gun driver in addition includes a controller configured to control the inverter. The electrostatic gun driver moreover includes a filter configured to generate a sinewave drive signal and provide the sinewave drive signal to a material application system and/or a material application device.

### CROSS-REFERENCE TO RELATED APPLICATIONS

This application is a National Stage Application of International Patent App. No. PCT/US2023/076661, filed Oct. 12, 2023, which claims the benefit of U.S. Provisional Patent App. No. 63/420,968, filed Oct. 31, 2022, the entire disclosures of both of which are hereby incorporated by reference as if set forth in their entirety herein.

### FIELD OF THE DISCLOSURE

The disclosure relates to an electrostatic gun driver. Moreover, the disclosure relates to a process of implementing an electrostatic gun driver.

### BACKGROUND OF THE DISCLOSURE

Powder coating material such as powder paint is commonly applied to an object by spraying the powder coating material. Typically, a spray gun or material application device is used, and spray guns may be manually held and operated or automatic spray guns may be used that are controlled electronically. Spray technologies include for example electrostatic, non-electrostatic, tribo-electric, and/or the like.

Typically, as illustrated in FIG. 13, a gun driver circuit uses a DC supply and provides a drive waveform to the spray guns. In particular, the DC supply together with a boost converter power stage, such as a flyback converter, a DC inverter, and/or the like is used to provide a PWM drive waveform for the spray guns. However, the typical gun driver circuit has lower power efficiency. This results in waste heat 4895-5631-2636.1 generation. Further, this requires more costly cooling provisions. Moreover, the typical gun driver circuit has a larger form factor, which results in higher cost packaging. Further, the typical gun driver circuit requires utilization of many electrical circuit components. This results in a larger sized design and a higher cost gun drive circuit. Further, the typical gun driver circuit implements a square PWM drive waveform which impacts performance.

Accordingly, a driver circuit is needed with improved power efficiency, less waste heat generation, lower cost cooling provisions, a smaller form factor, a smaller and lower cost packaging, a reduced electrical circuit component part count, better performance, and/or the like.

### SUMMARY OF THE DISCLOSURE

In one general aspect, an electrostatic gun driver includes an inverter configured to receive power from a power supply. The electrostatic gun driver in addition includes a controller configured to control the inverter. The electrostatic gun driver moreover includes a filter configured to generate a sinewave drive signal and provide the sinewave drive signal to a material application system and/or a material application device.

In one general aspect, a process includes configuring an inverter to receive power from a power supply. The process in addition includes configuring a controller to control the inverter. The process moreover includes generating a sinewave drive signal with a filter and provide the sinewave drive signal to a material application system and/or a material application device.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates a schematic of an electrostatic gun driver according to aspects of the disclosure implemented in a material application system.

FIG. 2 illustrates a schematic of an electrostatic gun driver according to aspects of the disclosure implemented in a material application system.

FIG. 3 illustrates an exemplary implementation of the electrostatic gun driver and the inverter according to aspects of the disclosure.

FIG. 4 illustrates an exemplary implementation of the electrostatic gun driver and the inverter according to aspects of the disclosure.

FIG. 5 illustrates a schematic of an electrostatic gun driver according to aspects of the disclosure.

FIG. 6 illustrates a schematic of an electrostatic gun driver according to aspects of the disclosure.

FIG. 7 illustrates an exemplary implementation of the filter according to aspects of the disclosure.

FIG. 8 illustrates an exemplary implementation of the filter according to aspects of the disclosure.

FIG. 9 illustrates an exemplary implementation of the inverter according to aspects of the disclosure.

FIG. 10 illustrates an exemplary implementation of the inverter according to FIG. 9.

FIG. 11 illustrates exemplary waveforms of the sinewave drive signal and the modulated voltage pulses according to the disclosure.

FIG. 12 illustrates an exemplary process of implementing an electrostatic gun driver of the disclosure.

FIG. 13 illustrates a prior art gun driver circuit.

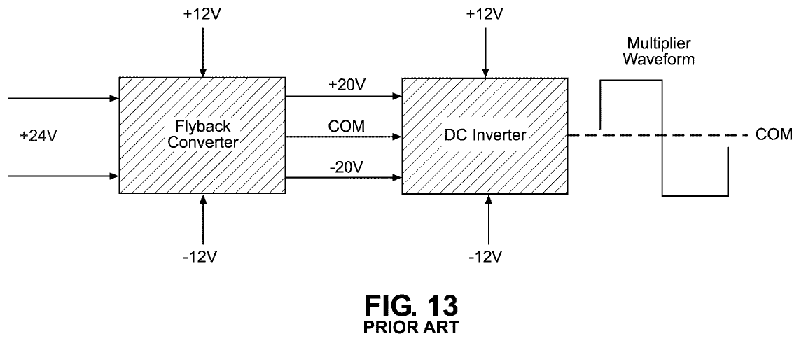

### DETAILED DESCRIPTION

The disclosure will now be described with reference to the drawing figures, in which like reference numerals refer to like parts throughout.

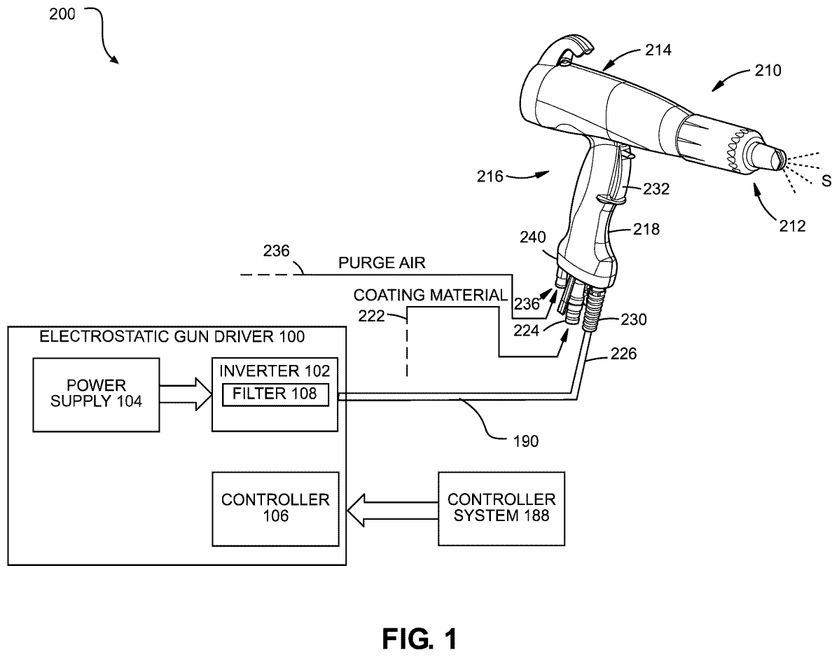

FIG. 1 illustrates a schematic of an electrostatic gun driver according to aspects of the disclosure implemented in a material application system.

In particular, FIG. 1 illustrates a schematic of an electrostatic gun driver 100 according to aspects of the disclosure. The electrostatic gun driver 100 may include an inverter 102, a controller 106, a filter 108, and/or the like. Further, the aspects of FIG. 1 and the description thereof, may be implemented in any other figures and/or aspects of the disclosure. Moreover, the aspects of any other figure and the description thereof, may be implemented in the aspects of FIG. 1.

Additionally, FIG. 1 illustrates a material application system 200 implementing an exemplary material application device 210. The electrostatic gun driver 100 is configured to generate a sinewave drive signal 190 and provide the sinewave drive signal 190 to the material application system 200 and/or the exemplary material application device 210. The inverter 102 of the electrostatic gun driver 100 may be configured to receive power from a power supply 104.

In comparison to the prior art drivers, the disclosed implementation of the electrostatic gun driver 100 implementing the inverter 102 provides improved power efficiency, results in less waste heat generation, lower cost cooling provisions, and/or the like for the electrostatic gun driver 100, the material application system 200, and/or the like. Moreover, the disclosed implementation of the electrostatic gun driver 100 implementing the inverter 102 may be implemented in a smaller form factor, which results in smaller lower cost packaging options. Further, the disclosed implementation of the electrostatic gun driver 100 implementing the inverter 102 may result in reduced electrical circuit component part count, which results in a smaller sized design and a lower cost gun drive circuit with the same or better (true sinewave) performance compared to prior art electrostatic gun drivers. In particular, the disclosed implementation of the electrostatic gun driver 100 implementing the inverter 102 may generate a true sinewave.

In aspects, the electrostatic gun driver 100, the inverter 102, and/or the like may be implemented separate from the exemplary material application device 210. In other aspects, the electrostatic gun driver 100, the inverter 102, and/or the like may be implemented within the exemplary material application device 210. In this regard, the disclosed aspects of the electrostatic gun driver 100, the inverter 102, and/or the like are configured, as described above, to be more compact and thus may be implemented within the exemplary material application device 210.

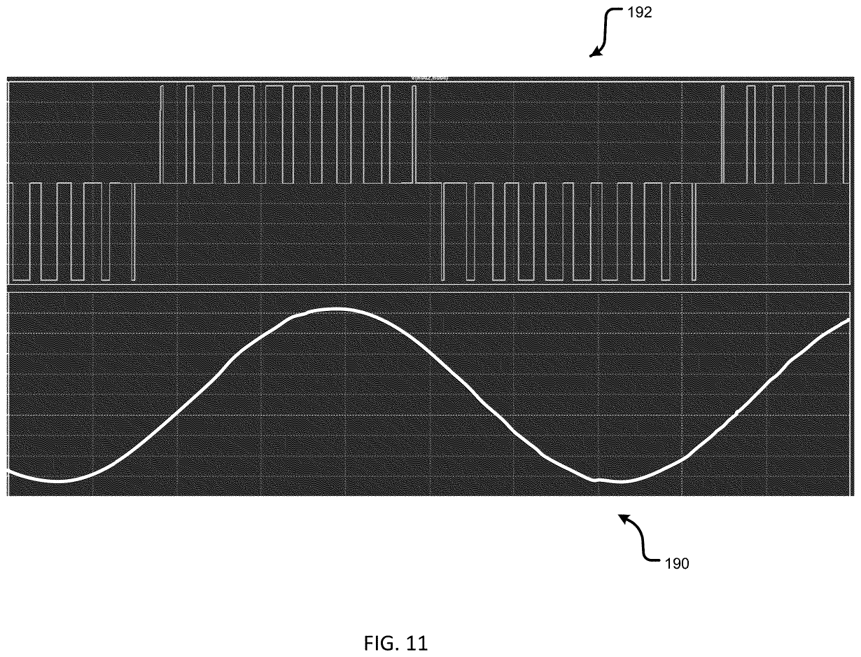

In aspects, the inverter 102 may be implemented as a four switch inverter that generates modulated voltage pulses 192 (as illustrated in FIG. 11) from the power supply 104. In aspects, the controller 106 may implement a unipolar modulation scheme to control a gating of two diagonal switch pairs of the inverter 102 to generate pulses which are modulated to generate the modulated voltage pulses 192. The filter 108 filters and smooths the modulated voltage pulses 192 into a sinewave drive signal 190 (as illustrated in FIG. 11) to drive the exemplary material application device 210.

In aspects, the electrostatic gun driver 100 implementing the inverter 102, the controller 106, and/or the filter 108 may generate the sinewave drive signal 190 to have a peak-to peak voltage sinewave directly from the power supply 104, such that a boost converter power stage, a flyback converter, a DC inverter, an/or the like can be eliminated from the design. This removal of a boost converter power stage, a flyback converter, a DC inverter, and/or the like increases the overall system efficiency of the electrostatic gun driver 100 and reduces the electrical component part count of the electrostatic gun driver 100. Moreover, the disclosed implementation of the electrostatic gun driver 100 reduces a required a circuit support substrate space, such as a Printed Circuit Board (PCB) space, which lowers the total cost and/or provides other benefits. Accordingly, in aspects, the electrostatic gun driver 100 is configured without a boost converter power stage, a flyback converter, and a DC inverter. In aspects, the electrostatic gun driver 100 is configured without a boost converter power stage; the electrostatic gun driver 100 is configured without a flyback converter; and/or the electrostatic gun driver 100 is configured without a DC inverter.

In aspects, the electrostatic gun driver 100 implementing the inverter 102, the controller 106, and/or the filter 108 may generate the sinewave drive signal 190 as a sinusoidal multiplier drive waveform compared to the existing square waveform and/or non-sinusoidal waveform of the existing driver design.

In aspects, the electrostatic gun driver 100 and/or the inverter 102 generates the sinewave drive signal 190 with a frequency. The frequency of the sinewave drive signal 190 may be 1 kHz to 1000 kHz, 1 kHz to 25 kHz, 25 kHz to 35 kHz, 28 kHz to 32 kHz, 35 kHz to 45 kHz, 45 kHz to 90 kHz, or 90 kHz to 100 kHz. In aspects, the electrostatic gun driver 100 and/or the inverter 102 generates the sinewave drive signal 190 with a voltage and/or amplitude. The voltage of the sinewave drive signal 190 may be 0 V peak-to-peak to 100 V peak-to-peak, 0 V peak-to-peak to 30 V peak-to-peak, 30 V peak-to-peak to 50 V peak-to-peak, 50 V peak-to-peak to 60 V peak-to-peak, 60 V peak-to-peak to 80 V peak-to-peak, or 80 V peak-to-peak to 100 V peak-to-peak.

In aspects, the power supply 104 may be an industrial standard power supply. In aspects, the power supply 104 may be an industrial standard DC power supply. In aspects, the power supply 104 may be an industrial standard DC power supply generating a DC voltage of 2 V to 100 V, 2 V to 20 V, 20 V to 30 V, 30 V to 60 V, or 60 V to 100 V.

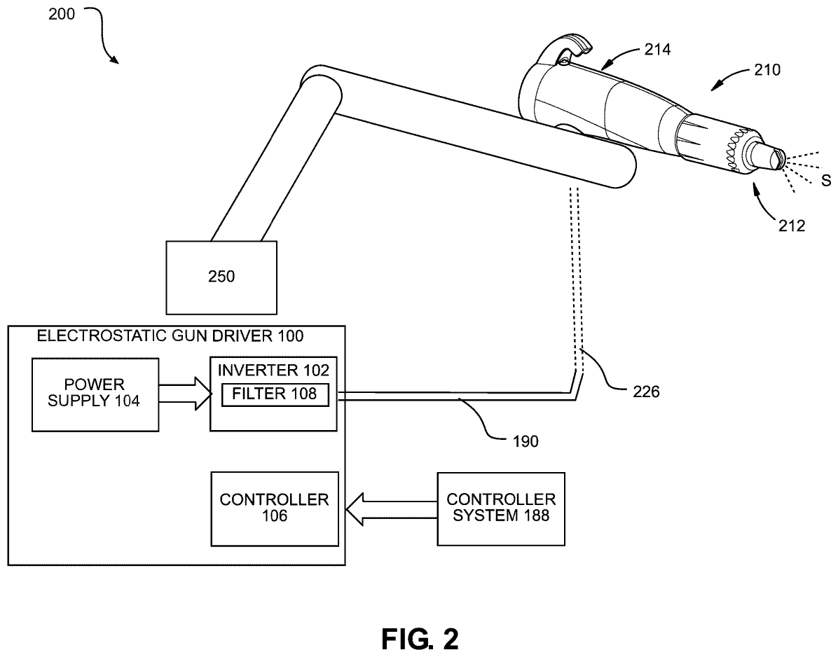

FIG. 1 further illustrates the exemplary material application device 210 configured to be implemented in conjunction with the electrostatic gun driver 100. In this regard, the exemplary material application device 210 may be implemented as a manually operated material application device. However, the disclosed implementation of the electrostatic gun driver 100 may also be implemented with other types and implementations of the exemplary material application device 210. For example, the exemplary material application device 210 may be a robotically operated implementation as illustrated in FIG. 2. In the examples herein, the exemplary material application device 210 may be, for example, any suitable material application device, a spray gun, a powder spray gun, and/or the like. However, it is to be understood that an exemplary material application device 210 may be realized in many forms other than just a spray gun and is not limited to that terminology.

The exemplary material application device 210 may include a nozzle portion 212, a barrel portion 214, an electrical cable 226, and/or the like. The electrical cable 226 or electrical connection may be provided between the electrostatic gun driver 100, a control system 188, and/or the like and an electrical input 230 of the exemplary material application device 210. The material application system 200, the control system 188 and/or the electrostatic gun driver 100 may receive one or more signals from the exemplary material application device 210, such as for example a trigger actuation signal that indicates that the operator has activated an actuation device 232. When the actuation device 232 is activated, an electrical signal or condition (such as closed contacts) is sent to or detected by the control system 188 to begin flow of coating material to the exemplary material application device 210, and other signals may be generated to activate electrical power that may be provided by the electrostatic gun driver 100 for the exemplary material application device 210. All electrical signals or conditions between the exemplary material application device 210 and the control system 188 or other system components may be transmitted along electrical lines through the electrical cable 226.

FIG. 2 illustrates a schematic of an electrostatic gun driver according to aspects of the disclosure implemented in a material application system.

In particular, FIG. 2 illustrates the electrostatic gun driver 100 implemented in the material application system 200. In aspects, the material application system 200 may include a robotic system 250 configured to operate within the material application system 200 and manipulate and move the exemplary material application device 210. Further, the aspects of FIG. 2 and the description thereof, may be implemented in any other figures and/or aspects of the disclosure. Moreover, the aspects of any other figure and the description thereof, may be implemented in the aspects of FIG. 2.

In aspects, the robotic system 250 may include one or more arms, one or more motors to move the one or more arms, which may provide up to three or more axes of movement. Additionally, the one or more arms may hold the exemplary material application device 210. In aspects, the one or more arms may include one or more suction cups, manipulators, and/or the like for grasping, moving, and/or the like the exemplary material application device 210. Additionally, the robotic system 250 may include a controller configured to control operation of the various components of the robotic system 250. Moreover, the robotic system 250 may include a vision system configured to help identify and locate objects within the material application system 200.

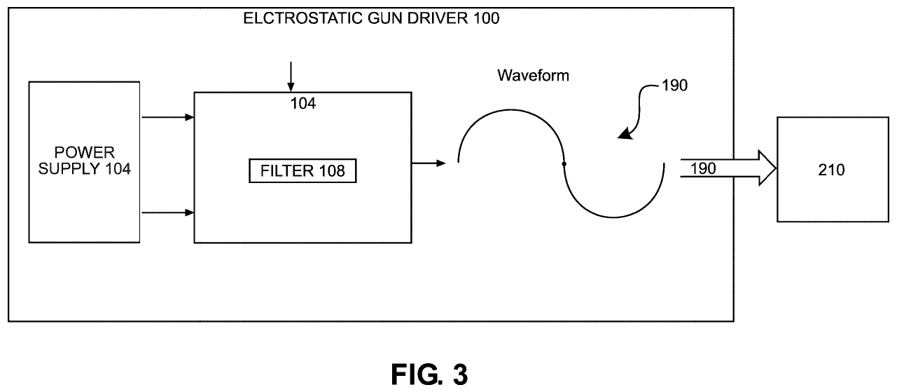

FIG. 3 illustrates an exemplary implementation of the electrostatic gun driver and the inverter according to aspects of the disclosure.

In particular, FIG. 3 illustrates an exemplary implementation of the electrostatic gun driver 100, the filter 108, and the inverter 102 according to aspects of the disclosure. Further, the aspects of FIG. 3 and the description thereof, may be implemented in any other figures and/or aspects of the disclosure. Moreover, the aspects of any other figure and the description thereof, may be implemented in the aspects of FIG. 3.

More specifically, FIG. 3 illustrates the electrostatic gun driver 100 is configured to generate the sinewave drive signal 190 and provide the sinewave drive signal 190 to the material application system 200 and/or the exemplary material application device 210. The inverter 102 of the electrostatic gun driver 100 may be configured to receive power from the power supply 104. The inverter 102 generates the modulated voltage pulses 192 and the filter 108 receives the modulated voltage pulses 192 and generates the sinewave drive signal 190.

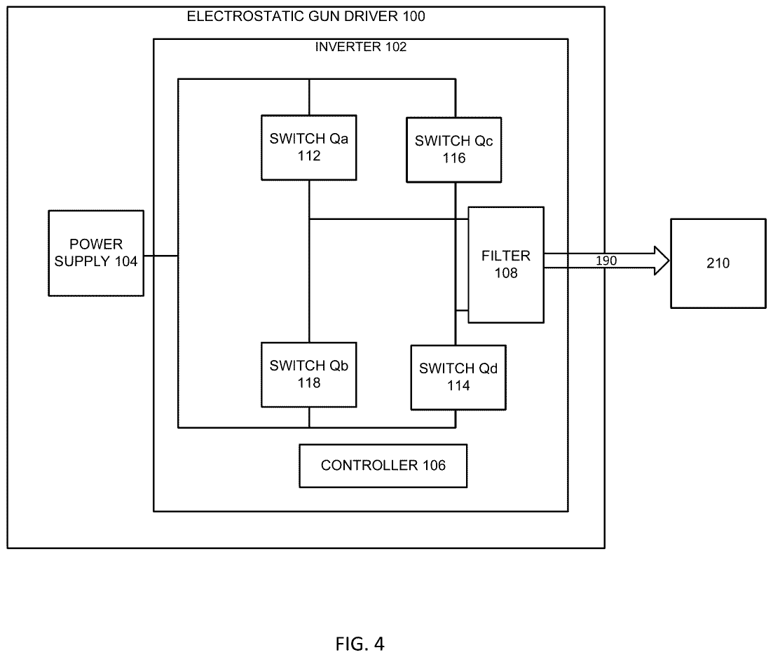

FIG. 4 illustrates an exemplary implementation of the electrostatic gun driver and the inverter according to aspects of the disclosure.

In particular, FIG. 4 illustrates an exemplary implementation of the electrostatic gun driver 100 and the inverter 102 according to aspects of the disclosure. Further, the aspects of FIG. 4 and the description thereof, may be implemented in any other figures and/or aspects of the disclosure. Moreover, the aspects of any other figure and the description thereof, may be implemented in the aspects of FIG. 4.

Additionally, the inverter 102 may include a first switch Qa 112, a fourth switch Qd 114, a third switch Qc 116, and a second switch Qb 118. The electrostatic gun driver 100 in conjunction with the inverter 102 may be configured to convert a direct current (DC) from the power supply 104 to alternating current (AC) for the exemplary material application device 210. In particular, the electrostatic gun driver 100 in conjunction with the inverter 102 may be configured to generate the modulated voltage pulses 192 from the power supply 104. In particular, the controller 106 may rapidly switch on and off power from the power supply 104 to the first switch Qa 112, the fourth switch Qd 114, the third switch Qc 116, and the second switch Qb 118. In aspects, one or more of the first switch Qa 112, the fourth switch Qd 114, the third switch Qc 116, and the second switch Qb 118 may be implemented as transistors, FETs, MOSFETS, and/or the like. In aspects, the inverter 102 may be implemented as a Half bridge inverter circuit with the first switch Qa 112, the fourth switch Qd 114, the third switch Qc 116, and the second switch Qb 118 when the first switch Qa 112 and the fourth switch Qd 114 are on and the third switch Qc 116 and the second switch Qb 118 are off.

In aspects, the inverter 102 may be implemented as a four switch inverter with the first switch Qa 112, the fourth switch Qd 114, the third switch Qc 116, and the second switch Qb 118 that generate pulses which are modulated to generate the modulated voltage pulses 192 from the power supply 104.

The filter 108 filters and smooths the modulated voltage pulses 192 generated by the power supply 104 into the sinewave drive signal 190. Thereafter, the filter 108 may provide the sinewave drive signal 190 to drive the exemplary material application device 210. In particular, the filter 108 may provide the sinewave drive signal 190 on the electrical cable 226 to drive the exemplary material application device 210.

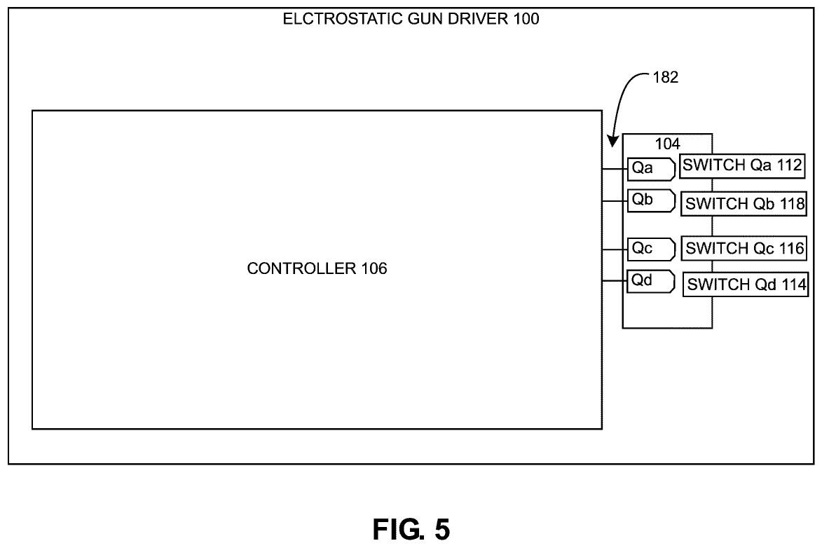

FIG. 5 illustrates a schematic of an electrostatic gun driver according to aspects of the disclosure.

In particular, FIG. 5 illustrates exemplary details of the power supply 104 and the controller 106. Further, the aspects of FIG. 5 and the description thereof, may be implemented in any other figures and/or aspects of the disclosure. Moreover, the aspects of any other figure and the description thereof, may be implemented in the aspects of FIG. 5.

In aspects, the inverter 102 may include signal lines 182 connecting the controller 106 to the first switch Qa 112, the fourth switch Qd 114, the third switch Qc 116, and the second switch Qb 118. In particular, the controller 106 may be configured to implement a unipolar modulation scheme to control a gating of the first switch Qa 112, the fourth switch Qd 114, the third switch Qc 116, and the second switch Qb 118.

More specifically, the controller 106 may be configured to implement a unipolar modulation scheme; and the unipolar modulation scheme may be implemented by the controller 106 as control signals on the signal lines 182. In aspects, the signal lines 182 may connect between the controller 106 and the first switch Qa 112, the fourth switch Qd 114, the third switch Qc 116, and the second switch Qb 118. Accordingly, the controller 106 may control the first switch Qa 112, the fourth switch Qd 114, the third switch Qc 116, and the second switch Qb 118 by other 182. In particular, the controller 106 may control two diagonal switch pairs of the first switch Qa 112, the fourth switch Qd 114, the third switch Qc 116, and the second switch Qb 118 of the inverter 102 to generate pulses which are modulated to generate modulated voltage pulses 192. In particular, the diagonal switch pairs may be the first switch Qa 112 and the fourth switch Qd 114; or the diagonal switch pairs may be the third switch Qc 116 and the second switch Qb 118.

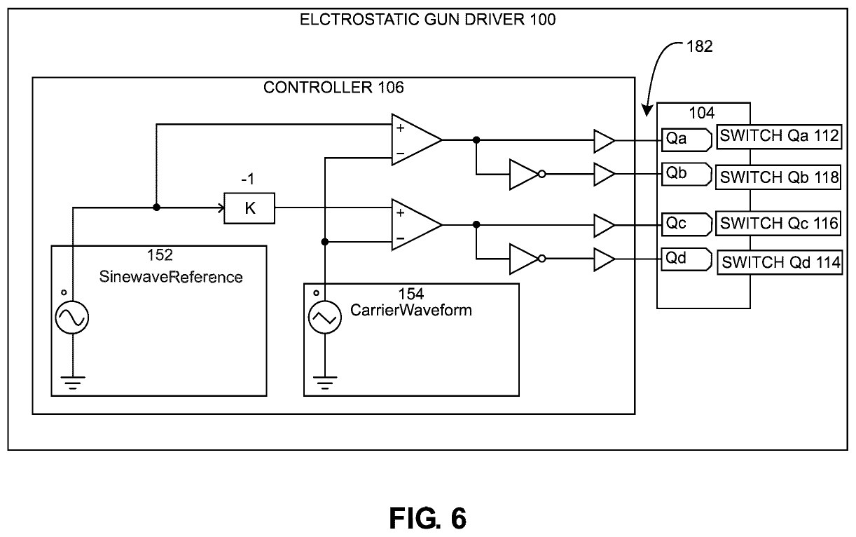

FIG. 6 illustrates a schematic of an electrostatic gun driver according to aspects of the disclosure.

In particular, FIG. 6 illustrates exemplary details of the power supply 104 and the controller 106. Further, the aspects of FIG. 6 and the description thereof, may be implemented in any other figures and/or aspects of the disclosure. Moreover, the aspects of any other figure and the description thereof, may be implemented in the aspects of FIG. 6.

As illustrated in FIG. 6, the controller 106 may implement a unipolar modulation scheme. In particular, the controller 106 may be configured to implement the unipolar modulation scheme by receiving a sinewave reference 152 and a carrier waveform 154. The sinewave reference 152 may be compared to the carrier waveform 154. For the left side of the bridge of the inverter 102 that includes the first switch Qa 112 and the second switch Qb 118, if a voltage of the sinewave reference 152 is higher than a voltage the carrier waveform 154, the first switch Qa 112 may switch ON, else the first switch Qa 112 switch OFF. The second switch Qb 118 is the inverse of the first switch Qa 112. The other side of the bridge of the inverter 102, the third switch Qc 116 and the fourth switch Qd 114 operate in the same manner but use the inverse of the voltage of the sinewave reference 152 as the reference.

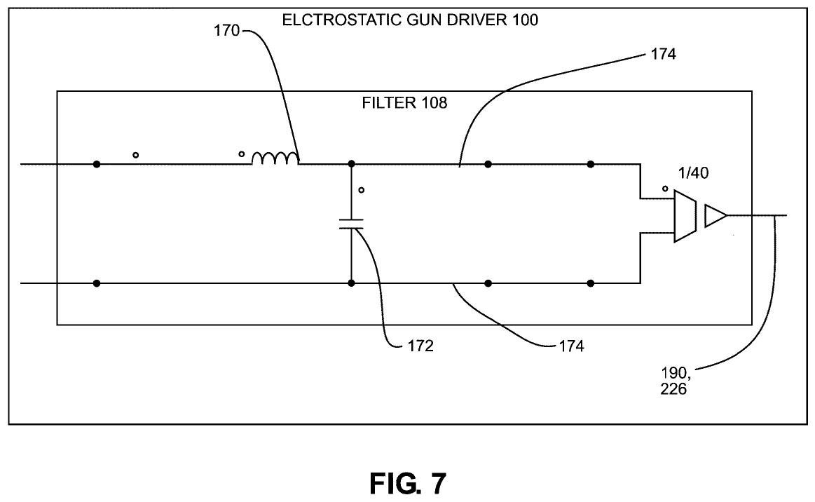

FIG. 7 illustrates an exemplary implementation of the filter according to aspects of the disclosure.

In particular, FIG. 7 illustrates an exemplary implementation of the filter 108 according to aspects of the disclosure. Further, the aspects of FIG. 7 and the description thereof, may be implemented in any other figures and/or aspects of the disclosure. Moreover, the aspects of any other figure and the description thereof, may be implemented in the aspects of FIG. 7.

As illustrated in FIG. 7, the filter 108 may include parallel powerlines 174. The parallel powerlines 174 may receive the modulated voltage pulses 192 generated by the inverter 102. Further, the filter 108 may filter and smooth the modulated voltage pulses 192 generated by the inverter 102 into the sinewave drive signal 190. Thereafter, the filter 108 may provide the sinewave drive signal 190 to drive the exemplary material application device 210. In particular, the filter 108 may provide the sinewave drive signal 190 on the electrical cable 226 to drive the exemplary material application device 210. In this regard, the filter 108 may implement any type of electronic filter technology implementing any type of electrical components.

In aspects, the filter 108 may include an inductor 170 and a capacitor 172. In aspects, the inductor 170 may be arranged in line on one implementation of the parallel powerlines 174. In aspects, the capacitor 172 may be arranged to connect between the parallel powerlines 174.

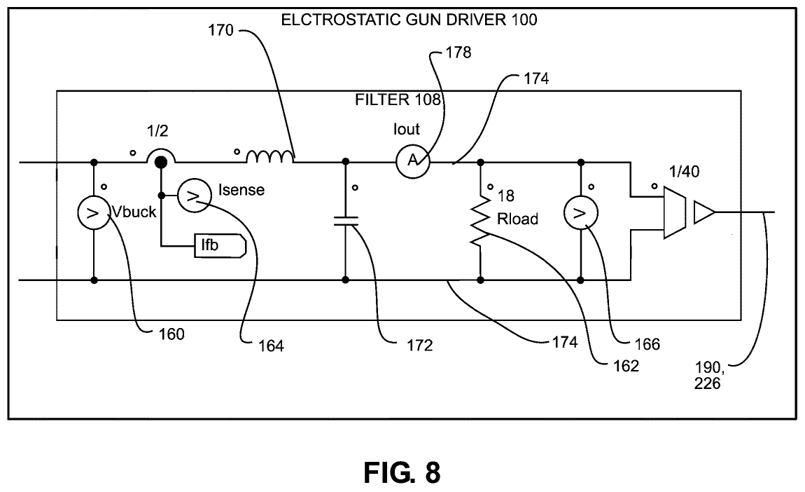

FIG. 8 illustrates an exemplary implementation of the filter according to aspects of the disclosure.

In particular, FIG. 8 illustrates an exemplary implementation of the filter 108 according to aspects of the disclosure. Further, the aspects of FIG. 8 and the description thereof, may be implemented in any other figures and/or aspects of the disclosure. Moreover, the aspects of any other figure and the description thereof, may be implemented in the aspects of FIG. 8.

In aspects, the filter 108 may include buck converter 160. In aspects, the buck converter 160 may be implemented as a step-down and/or step up converter. In aspects, the buck converter 160 may step down and/or step up a voltage of the power supply 104.

In aspects, the filter 108 may include a load resistor 162. The load resistor 162 may be connected between the parallel powerlines 174.

In aspects, the filter 108 may include a current sensor 164. The current sensor 164 may be connected in line on one of the parallel powerlines 174. In aspects, the current sensed by the current sensor 164 may be provided to the controller 106, the control system 188, the material application system 200, and/or the like.

In aspects, the filter 108 may include a voltage sensor 166. The voltage sensor 166 may be connected between the parallel powerlines 174. In aspects, the voltage sensed by the voltage sensor 166 may be provided to the controller 106, the control system 188, the material application system 200, and/or the like.

In aspects, the filter 108 may include a current sensor 178. The current sensor 178 may be connected in line on one of the parallel powerlines 174. In aspects, the current sensed by the current sensor 164 may be provided to the controller 106, the control system 188, the material application system 200, and/or the like.

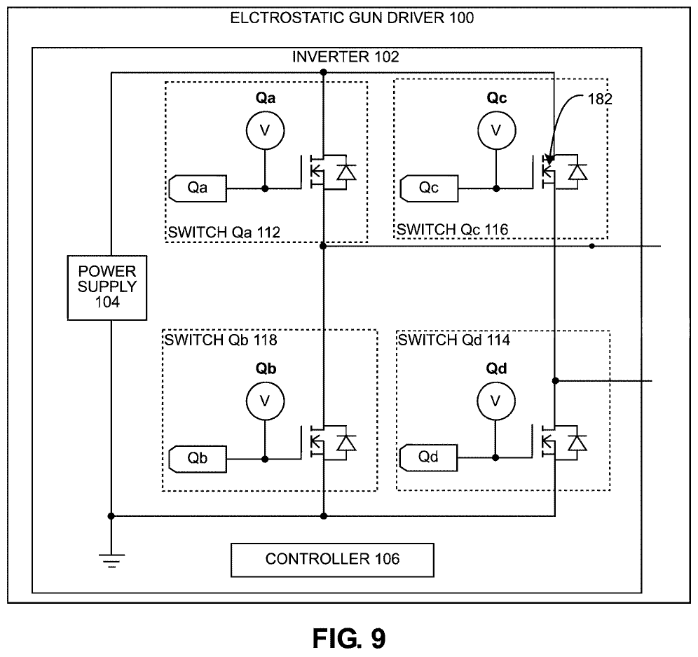

FIG. 9 illustrates an exemplary implementation of the inverter according to aspects of the disclosure.

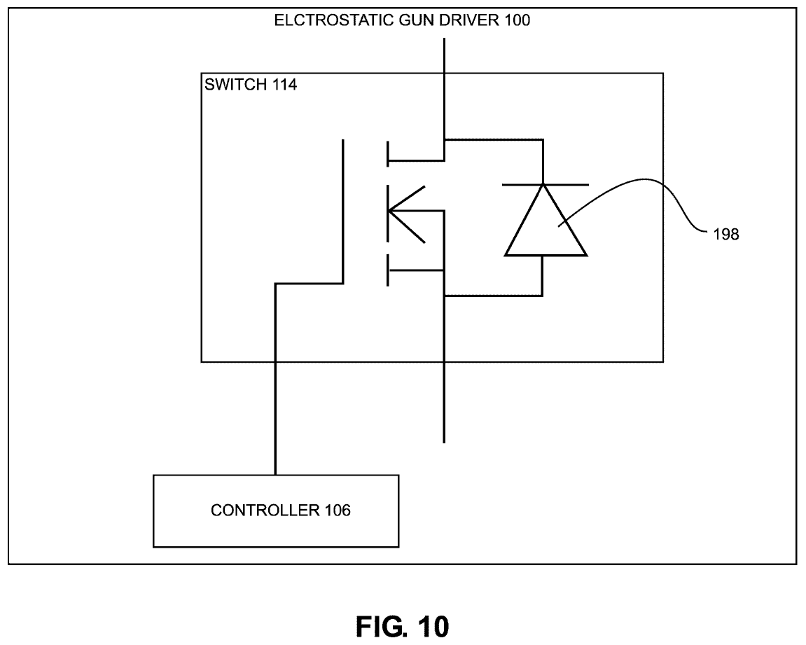

FIG. 10 illustrates an exemplary implementation of the inverter according to FIG. 9.

In particular, FIG. 9 and FIG. 10 illustrate an exemplary implementation of the inverter 102 according to aspects of the disclosure. Further, the aspects of FIG. 9 and FIG. 10 and the description thereof, may be implemented in any other figures and/or aspects of the disclosure. Moreover, the aspects of any other figure and the description thereof, may be implemented in the aspects of FIG. 9 and FIG. 10.

In aspects, the inverter 102 may be implemented as a half bridge inverter circuit with the first switch Qa 112, the fourth switch Qd 114, the third switch Qc 116, and the second switch Qb 118. In aspects, the first switch Qa 112, the fourth switch Qd 114, the third switch Qc 116, and the second switch Qb 118 may include antiparallel diodes. As illustrated in FIG. 10, the fourth switch Qd 114 is illustrated in detail with an implementation of an antiparallel diode 198.

FIG. 11 illustrates exemplary waveforms of the sinewave drive signal and the modulated voltage pulses according to the disclosure.

In particular, FIG. 11 illustrates exemplary waveforms of the sinewave drive signal 190 and the modulated voltage pulses 192 generated by various components of the electrostatic gun driver 100. In this regard, the sinewave drive signal 190 generated by the electrostatic gun driver 100 may be a true sinusoidal sinewave.

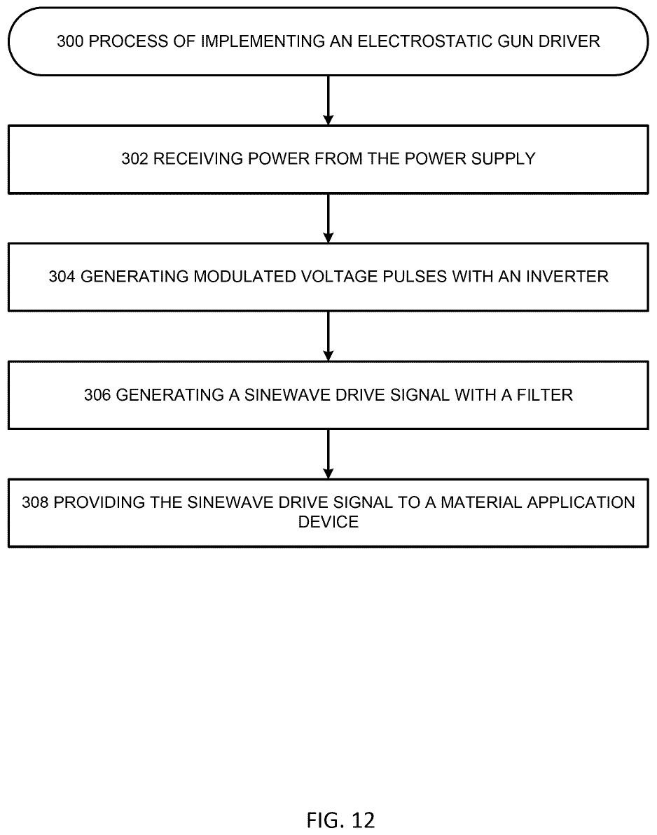

FIG. 12 illustrates an exemplary process of implementing an electrostatic gun driver of the disclosure.

In particular, FIG. 12 shows an exemplary process of implementing an electrostatic gun driver 300 of the disclosure. In particular, it should be noted that the process of implementing an electrostatic gun driver 300 is merely exemplary and may be modified consistent with the various aspects disclosed herein. It should be noted that the process of implementing an electrostatic gun driver 300 may be performed in a different order consistent with the aspects described above. Moreover, the process of implementing an electrostatic gun driver 300 may be modified to have more or fewer process steps consistent with the various aspects disclosed herein. In particular, the process of implementing an electrostatic gun driver 300 may be a process of implementing the electrostatic gun driver 100 according to the disclosure.

The process of implementing an electrostatic gun driver 300 of the disclosure may include receiving power from the power supply 302. In this regard, the receiving power from the power supply 302 may include any one or more materials, structures, arrangements, processes, and/or the like as described herein. Moreover, one or more proceeding or subsequent processes may also be implemented with respect to the receiving power from the power supply 302 consistent with the disclosure. In particular, the receiving power from the power supply 302 may include receiving power from the power supply 104.

The process of implementing an electrostatic gun driver 300 of the disclosure may include generating the modulated voltage pulses with the inverter 304. In this regard, the generating the modulated voltage pulses with the inverter 304 may include any one or more materials, structures, arrangements, processes, and/or the like as described herein. Moreover, one or more proceeding or subsequent processes may also be implemented with respect to the generating the modulated voltage pulses with the inverter 304 consistent with the disclosure. In particular, the generating the modulated voltage pulses with the inverter 304 may include generating the modulated voltage pulses 192 with the inverter 102.

The process of implementing an electrostatic gun driver 300 of the disclosure may include generating a sinewave drive signal with a filter 306. In this regard, the generating a sinewave drive signal with a filter 306 may include any one or more materials, structures, arrangements, processes, and/or the like as described herein. Moreover, one or more proceeding or subsequent processes may also be implemented with respect to the generating a sinewave drive signal with a filter 306 consistent with the disclosure. In particular, the generating a sinewave drive signal with a filter 306 may include generating the sinewave drive signal 190 with the filter 108.

The process of implementing an electrostatic gun driver 300 of the disclosure may include providing the sinewave drive signal to a material application device 308. In this regard, the providing the sinewave drive signal to a material application device 308 may include any one or more materials, structures, arrangements, processes, and/or the like as described herein. Moreover, one or more proceeding or subsequent processes may also be implemented with respect to the providing the sinewave drive signal to a material application device 308 consistent with the disclosure. In particular, the providing the sinewave drive signal to a material application device 308 may include providing the sinewave drive signal 190 to the exemplary material application device 210.

Referring back to FIG. 1, In aspects, the exemplary material application device 210 may include a handgrip portion 216. The handgrip portion 216 may be realized, for example, in the form of a handle 218 that is manually held or gripped during operation of the exemplary material application device 210. For the exemplary material application device 210, the handle 218 may include a portion that contacts the operator's hand and is grounded. For purposes of this description, the term handgrip is generally used to refer to any structure or assembly or member that is manually held or gripped by an operator during operation of the exemplary material application device 210 to support and control the exemplary material application device 210, with a handle, grip or other structure being exemplary embodiments of such a handgrip.

As further illustrated in FIG. 1, a coating material supply may be used as a source of coating material to the exemplary material application device 210. A feed or supply hose 222 may be used to connect the exemplary material application device 210 with the coating material supply. A hose connector 224 may be provided to securely attach the supply hose 222 to the exemplary material application device 210. The control system 188 and/or the electrostatic gun driver 100 may be configured for controlling input power and operation of the spray gun electrical requirements, as well as controlling operation of the coating material supply, a purge supply and other system related features such as a spray booth, parts conveyor and so on (not shown). The coating material supply typically includes a pump or pumps under the control of the control system 188 so that the control system 188 starts the pump in response to the operator actuating the actuation device 232. This causes coating material to flow through the handle 218, the barrel portion 214 and out through the nozzle portion 212 to form a desired spray pattern S, typically in the form of a cloud like pattern for powder coating material, for example.

A purge supply under the control of the control system 188 may be used to provide pressurized purge air or other gas through a purge hose 236 to the exemplary material application device 210. The purge hose 236 may be connectable to a suitable hose connector input disposed on the handgrip portion 216, and in this example a base 240 of the handle 218. The purge air inlet to the handgrip portion 216 may thus be separate from the coating material input at the hose connector 224, so that purge air initially enters a coating material flow path (not shown in FIG. 1) by first passing through a purge air flow path within the handgrip portion 216.

Accordingly, the disclosure as set forth a driver circuit is needed with improved power efficiency, less waste heat generation, lower cost cooling provisions, a smaller form factor, a smaller and lower cost packaging, a reduced electrical circuit component part count, better performance, and/or the like.

The following are a number of nonlimiting EXAMPLES of aspects of the disclosure.

One EXAMPLE includes: the electrostatic gun driver includes an inverter configured to receive power from a power supply. The electrostatic gun driver in addition includes a controller configured to control the inverter. The electrostatic gun driver moreover includes a filter configured to generate a sinewave drive signal and provide the sinewave drive signal to a material application system and/or a material application device.

The above-noted EXAMPLE may further include any one or a combination of more than one of the following EXAMPLES: The electrostatic gun driver of the above-noted EXAMPLE where the inverter configured to generate a true sinewave. The electrostatic gun driver of the above-noted EXAMPLE where the inverter is implemented as a four switch inverter that generates modulated voltage pulses from the power supply. The electrostatic gun driver of the above-noted EXAMPLE where the controller configured to implement a unipolar modulation scheme to control a gating of two diagonal switch pairs of the inverter to generate pulses which are modulated to generate modulated voltage pulses. The electrostatic gun driver of the above-noted EXAMPLE where the filter is configured to filter and smooth the modulated voltage pulses into the sinewave drive signal to drive the material application device. The electrostatic gun driver of the above-noted EXAMPLE where the electrostatic gun driver is configured without a boost converter power stage. The electrostatic gun driver of the above-noted EXAMPLE where the electrostatic gun driver is configured without a flyback converter. The electrostatic gun driver of the above-noted EXAMPLE where the electrostatic gun driver is configured without a DC inverter. The electrostatic gun driver of the above-noted EXAMPLE where the electrostatic gun driver and/or the inverter generates the sinewave drive signal with a frequency of 1 kHz to 1000 kHz. The electrostatic gun driver of the above-noted EXAMPLE where the electrostatic gun driver and/or the inverter generates the sinewave drive signal with a voltage and/or amplitude of 0 V peak-to-peak to 1000 V peak-to-peak. The electrostatic gun driver of the above-noted EXAMPLE where the inverter generates modulated voltage pulses and the filter receives the modulated voltage pulses and generates the sinewave drive signal. The electrostatic gun driver of the above-noted EXAMPLE where the inverter may include a first switch, a fourth switch, a third switch, and a second switch. The electrostatic gun driver of the above-noted EXAMPLE where the controller is configured to switch on and off power from the power supply to the first switch, the fourth switch, the third switch, and the second switch. The electrostatic gun driver of the above-noted EXAMPLE where one or more of the first switch, the fourth switch, the third switch, and the second switch our implemented as transistors, FETs, and/or MOSFETs. The electrostatic gun driver of the above-noted EXAMPLE where the controller is configured to implement a unipolar modulation scheme to control a gating of the first switch, the fourth switch, the third switch, and the second switch. The electrostatic gun driver of the above-noted EXAMPLE where the controller is configured to control two diagonal switch pairs of the first switch, the fourth switch, the third switch, and the second switch of the inverter to generate pulses which are modulated to generate modulated voltage pulses. The electrostatic gun driver of the above-noted EXAMPLE where the controller is configured to implement a unipolar modulation scheme by receiving a sinewave reference and a carrier waveform. The electrostatic gun driver of the above-noted EXAMPLE where the controller is configured to compare the sinewave reference to the carrier waveform to control the first switch, the second switch, the third switch, and the fourth switch. The electrostatic gun driver of the above-noted EXAMPLE where the filter may include an inductor and a capacitor. The electrostatic gun driver of the above-noted EXAMPLE where the inductor is arranged in line on one implementation of parallel powerlines. The electrostatic gun driver of the above-noted EXAMPLE where the capacitor is arranged to connect between parallel powerlines. The electrostatic gun driver of the above-noted EXAMPLE where the inverter configured to provide improved power efficiency compared to prior art electrostatic gun drivers. The electrostatic gun driver of the above-noted EXAMPLE where the inverter configured to provide less waste heat generation compared to prior art electrostatic gun drivers. The electrostatic gun driver of the above-noted EXAMPLE where the inverter configured to provide a smaller form factor compared to prior art electrostatic gun drivers. The electrostatic gun driver of the above-noted EXAMPLE where the material application device is implemented as a manually operated material application device. The electrostatic gun driver of the above-noted EXAMPLE where the material application device is robotically operated. The electrostatic gun driver of the above-noted EXAMPLE where the material application system may include a robotic system configured to operate within the material application system and manipulate and move the material application device. The material application system of the above-noted EXAMPLE. The material application system of the above-noted EXAMPLE where the material application device is implemented as a manually operated material application device. The material application system of the above-noted EXAMPLE where the material application device is robotically operated. The material application system of the above-noted EXAMPLE where the material application system may include a robotic system configured to operate within the material application system and manipulate and move the material application device.

One EXAMPLE includes: the process includes configuring an inverter to receive power from a power supply. The process in addition includes configuring a controller to control the inverter. The process moreover includes generating a sinewave drive signal with a filter and provide the sinewave drive signal to a material application system and/or a material application device.

The above-noted EXAMPLE may further include any one or a combination of more than one of the following EXAMPLES: The process of the above-noted EXAMPLE where the inverter configured to generate a true sinewave. The process of the above-noted EXAMPLE where the inverter is implemented as a four switch inverter that generates modulated voltage pulses from the power supply. The process of the above-noted EXAMPLE where the controller configured to implement a unipolar modulation scheme to control a gating of two diagonal switch pairs of the inverter to generate pulses which are modulated to generate modulated voltage pulses. The process of the above-noted EXAMPLE where the filter is configured to filter and smooth the modulated voltage pulses into the sinewave drive signal to drive the material application device. The process of the above-noted EXAMPLE where the electrostatic gun driver is configured without a boost converter power stage. The process of the above-noted EXAMPLE where the electrostatic gun driver is configured without a flyback converter. The process of the above-noted EXAMPLE where the electrostatic gun driver is configured without a DC inverter. The process of the above-noted EXAMPLE where the electrostatic gun driver and/or the inverter generates the sinewave drive signal with a frequency of 1 kHz to 1000 kHz. The process of the above-noted EXAMPLE where the electrostatic gun driver and/or the inverter generates the sinewave drive signal with a voltage and/or amplitude of 0 V peak-to-peak to 1000 V peak-to-peak. The process of the above-noted EXAMPLE where the inverter generates modulated voltage pulses and the filter receives the modulated voltage pulses and generates the sinewave drive signal. The process of the above-noted EXAMPLE where the inverter may include a first switch, a fourth switch, a third switch, and a second switch. The process of the above-noted EXAMPLE where the controller is configured to switch on and off power from the power supply to the first switch, the fourth switch, the third switch, and the second switch. The process of the above-noted EXAMPLE where one or more of the first switch, the fourth switch, the third switch, and the second switch our implemented as transistors, FETs, and/or MOSFETs. The process of the above-noted EXAMPLE where the controller is configured to implement a unipolar modulation scheme to control a gating of the first switch, the fourth switch, the third switch, and the second switch. The process of the above-noted EXAMPLE where the controller is configured to control two diagonal switch pairs of the first switch, the fourth switch, the third switch, and the second switch of the inverter to generate pulses which are modulated to generate modulated voltage pulses. The process of the above-noted EXAMPLE where the controller is configured to implement a unipolar modulation scheme by receiving a sinewave reference and a carrier waveform. The process of the above-noted EXAMPLE where the controller is configured to compare the sinewave reference to the carrier waveform to control the first switch, the second switch, the third switch, and the fourth switch. The process of the above-noted EXAMPLE where the filter may include an inductor and a capacitor. The process of the above-noted EXAMPLE where the inductor is arranged in line on one implementation of parallel powerlines. The process of the above-noted EXAMPLE where the capacitor is arranged to connect between parallel powerlines. The process of the above-noted EXAMPLE where the inverter configured to provide improved power efficiency compared to prior art electrostatic gun drivers. The process of the above-noted EXAMPLE where the inverter configured to provide less waste heat generation compared to prior art electrostatic gun drivers. The process of the above-noted EXAMPLE where the inverter configured to provide a smaller form factor compared to prior art electrostatic gun drivers. The process of the above-noted EXAMPLE where the material application device is implemented as a manually operated material application device. The process of the above-noted EXAMPLE where the material application device is robotically operated. The process of the above-noted EXAMPLE where the material application system may include a robotic system configured to operate within the material application system and manipulate and move the material application device. The process of the above-noted EXAMPLE. The process of the above-noted EXAMPLE where the material application device is implemented as a manually operated material application device. The process of the above-noted EXAMPLE where the material application device is robotically operated. The process of the above-noted EXAMPLE where the material application system may include a robotic system configured to operate within the material application system and manipulate and move the material application device.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. An electrostatic gun driver comprising:
an inverter configured to receive power from a power supply;
a controller configured to control the inverter; and
a filter configured to generate a sinewave drive signal and provide the sinewave drive signal to a material application system and/or a material application device.

2. (canceled)

3. The electrostatic gun driver according to claim 1 wherein the inverter is implemented as a four switch inverter that generates modulated voltage pulses from the power supply.

4. The electrostatic gun driver according to claim 1 wherein the controller configured to implement a unipolar modulation scheme to control a gating of two diagonal switch pairs of the inverter to generate pulses which are modulated to generate modulated voltage pulses.

5. The electrostatic gun driver according to claim 4 wherein the filter is configured to filter and smooth the modulated voltage pulses into the sinewave drive signal to drive the material application device.

6. The electrostatic gun driver according to claim 1 wherein the electrostatic gun driver is configured without a boost converter power stage, a flyback converter, and/or a DC inverter.

7.-10. (canceled)

11. The electrostatic gun driver according to claim 1 wherein the inverter generates modulated voltage pulses and the filter receives the modulated voltage pulses and generates the sinewave drive signal.

12. The electrostatic gun driver according to claim 1 wherein the inverter comprises a first switch, a fourth switch, a third switch, and a second switch.

13. The electrostatic gun driver according to claim 12 wherein the controller is configured to switch on and off power from the power supply to the first switch, the fourth switch, the third switch, and the second switch.

14. (canceled)

15. The electrostatic gun driver according to claim 12 wherein the controller is configured to implement a unipolar modulation scheme to control a gating of the first switch, the fourth switch, the third switch, and the second switch.

16. The electrostatic gun driver according to claim 12 wherein the controller is configured to control two diagonal switch pairs of the first switch, the fourth switch, the third switch, and the second switch of the inverter to generate pulses which are modulated to generate modulated voltage pulses.

17. The electrostatic gun driver according to claim 12 wherein the controller is configured to implement a unipolar modulation scheme by receiving a sinewave reference and a carrier waveform.

18. The electrostatic gun driver according to claim 17 wherein the controller is configured to compare the sinewave reference to the carrier waveform to control the first switch, the second switch, the third switch, and the fourth switch.

19. The electrostatic gun driver according to claim 1 wherein the filter comprises an inductor and a capacitor.

20. The electrostatic gun driver according to claim 19 wherein the inductor is arranged in line on one implementation of parallel powerlines.

21. The electrostatic gun driver according to claim 19 wherein the capacitor is arranged to connect between parallel powerlines.

22.-24. (canceled)

25. The electrostatic gun driver according to claim 1 wherein the material application device is implemented as a manually operated material application device.

26. The electrostatic gun driver according to claim 1 wherein the material application device is robotically operated.

27. The electrostatic gun driver according to claim 1 wherein the material application system comprises a robotic system configured to operate within the material application system and manipulate and move the material application device.

28. A material application system implementing the electrostatic gun driver and the material application device according to claim 1.

29.-31. (canceled)

32. A process of implementing an electrostatic gun driver comprising:
configuring an inverter to receive power from a power supply;
configuring a controller to control the inverter; and
generating a sinewave drive signal with a filter and provide the sinewave drive signal to a material application system and/or a material application device.

33.-62. (canceled)
